(19) United States
(12) Patent Application Publication
(10) Pub. No.: US 2017/0150069 A1
(43) Pub. Date: May 25, 2017

(54) THERMAL IMAGING BASED MONITORING SYSTEM

(71) Applicant: Seek Thermal, Inc., Santa Barbara, CA (US)

(72) Inventors: William J. Parrish, Santa Barbara, CA (US); Blake Henry, Santa Barbara, CA (US)

(21) Appl. No.: 15/342,469

(22) Filed: Nov. 3, 2016

Related U.S. Application Data
(60) Provisional application No. 62/259,519, filed on Nov. 24, 2015.

(51) Int. Cl. H04N 5/33; G06K 9/00; H04N 7/18; H04N 5/232

(52) U.S. Cl. CPC H04N 5/33; H04N 5/23241; G06K 9/00771; G06K 9/00536; H04N 7/181

(57) ABSTRACT

Systems and methods for thermal monitoring of a Field of View (FOV), including at least one thermal imaging module. The thermal imaging module includes an Infrared Focal Plane Array (IR FPA) and optics for producing a thermal image of a scene including a portion of the FOV, at least one processor, a battery based power supply controlled by the processor, and a network interface to the processor. Also included is an application executing on the processor, configured to put the module into a low power mode, wherein only minimal timing and network interface functions are operable, for at least one of predetermined intervals or in response to a network wake-up command, power up module and acquire thermal image data of the scene, segment the image of the scene into two or more regions, perform thermographic analysis to determine the temperature of each region, return to low power mode and repeat, and at least one system controller in communication with the modules over the network.

The specification relates to thermal monitoring of a space and in particular to one or more networked thermal imaging modules.

The increasing availability of high performance, low cost uncooled infrared imaging devices, such as bolometer focal plane arrays, is enabling the design and production of mass produced, consumer oriented IR cameras capable of quality thermal imaging. Such thermal imaging sensors have long been expensive and difficult to produce, thus limiting the employment of high performance, long wave imaging to high value instruments, such as aerospace, military, or large scale commercial applications. Mass produced, inexpensive thermal imagers may enable new methodologies for thermal monitoring of enclosed or non-enclosed spaces.

### BRIEF DESCRIPTION

In some embodiments, system or methods may be provided for one or more battery operated thermal imaging modules mounted to observe part or all of a space, and configured to operate in a low power quiescent mode and wake-up intermittently to thermally image a portion of a space and analyze the portion thermographically. In some embodiments the module may include a general purpose thermal imaging sub-module and a site specific base sub-module. In some embodiments, the thermal imaging modules may be controlled and accessed, as well as data acquired being stored and processed through one or more servers on a network such as the internet.

In some embodiments, system for thermal monitoring of a Field of View (FOV), is provided which may include at least one thermal imaging module. The thermal imaging module includes an Infrared Focal Plane Array (IR FPA) and optics for producing a thermal image of a scene including a portion of the FOV, at least one processor, a battery based power supply controlled by the processor, and a network interface to the processor. Also included is an application executing on the processor, configured to put the module into a low power mode, wherein only minimal timing and network interface functions are operable, for at least one of predetermined intervals or in response to a network wake-up command, power up module and acquire thermal image data of the scene, segment the image of the scene into two or more regions, perform thermographic analysis to determine the temperature of each region, return to low power mode and repeat, and at least one system controller in communication with the modules over the network.

In some embodiments, a method for thermal monitoring of a FOV may be provided utilizing one or more networked interfaced, battery powered thermal imaging modules capable of operating in low power quiescent and active modes, comprising; waking up the imaging module on at least one of a periodic time interval or in response to a wake-up command received over the network; acquiring scene image data of at least a portion of the FOV, segmenting the image of the scene into at least two regions performing a thermographic analysis of the image data to determine a temperature of each region, returning to low power mode and repeating steps a-d. The method of claim 16 wherein the thermographic analysis includes one or more of average, median, minimum or maximum temperature of the regions.

In some embodiments a system for thermal monitoring of a Field of View (FOV) may be provided including at least one thermal imaging module, the thermal imaging module including a first sub-module including an Infrared Focal Plane Array (IR FPA) and optics for producing a thermal image of a scene including a portion of the FOV, at least one processor, and a signal/power interface to a second sub-module, the second sub-module including at least one processor, a power supply controlled by the processor, a signal/power interface to the first sub-module and a network interface to the processor, and applications executing on the processors, configured to acquire thermal image data and send over the network interface, and accept commands including alarm conditions and set-up information including thermal image pre-processing, and at least one system controller in communication with the modules over the network, wherein the first sub-module is a generic thermal imaging component, the second sub-module is an installation specific sub-module and the two interface together to form a environmental monitoring thermal imaging module.

In some embodiments a method for thermal monitoring of a FOV may be provided utilizing one or more networked interfaced, thermal imaging modules capable of operating in low power quiescent and active modes, including a shutter and a thermal sensor, including waking up the imaging module on at least one of a periodic time interval or in response to a wake-up command received over the network, wherein that interval is of sufficient time for the thermal sensor and shutter to reach thermal equilibrium, acquiring at least one of a frame of image data with the shutter closed, at least one frame with the shutter open, or both shutter open and shutter closed frames of at least a portion of the FOV, segmenting the image of the scene into at least two regions determining if intensity of region from a shutter open frame exceeds a predetermined difference from the intensity of the region with the shutter closed, returning to low power mode and repeating the above steps. In some embodiments, depending on if the region intensity differences exceed the predetermined threshold, at least one of sending at least one of an alert or region temperature data over the network interface, or sending a scene thermal image over the network interface.

In some embodiments applications may be further configured to, depending on the region temperatures determined, at least one of sending region temperature over the network; send at least one of an alert or region temperature data over the network interface if the temperature of any region deviates from a predetermined range, or send a scene thermal image over the network interface.

In some embodiments the network interface may be a low power local network.

In some embodiments the network interface may communicate to at least one of a local bridge which in turn communicates over the internet, or directly to the internet.

In some embodiments the network interface may include at least one of Bluetooth, Zigbee, wi-fi, cellular, satellite telephone, or IR.

In some embodiments the thermographic analysis may include one or more of average, median, minimum or maximum temperature of the regions.

In some embodiments the network may be smart Bluetooth and the bridge is a Bluetooth bridge.

In some embodiments the system controller functions may reside in one or more servers on the internet.

In some embodiments the server system controller functions may include messaging, data storage, data processing, and a web portal.

In some embodiments, the first sub-module may be a generic thermal imaging component, the second sub-module may be an installation specific sub-module and the two interface together to form a environmental monitoring thermal imaging module.

In some embodiments environmental monitors from multiple users may interface with the server functions and each user may access their environmental monitors and associated data through an account.

In some embodiments system operation protocol which may include one or more of environmental monitor set-up, data processing protocol, alarm conditions, notification configuration, and data retrieval/display may be accessed through the web portal server function.

In some embodiments notifications, which may include any alarm conditions, may be sent from the servers to users through one or more of email, text messages, telephone calls, or direct communication to user facility automation.

In some embodiments data patterns and trends may be monitored over time by long term storage and analysis of monitor data.

In some embodiments the environmental monitor may include sensors including one or more of visual imager, ambient temperature sensor, ambient humidity sensor, local power monitor, and GPS module.

In some embodiments a rechargeable battery may be included, wherein the battery may be charged by one of a solar recharger or an local power charger.

### BRIEF DESCRIPTION OF THE DRAWINGS

FIG. 1 illustrates an embodiment of the invention;

FIG. 2 illustrates a general example of a thermal imaging module according to illustrative embodiments;

FIG. 3 illustrates a general thermal imaging module in communication with a network bridge according to an illustrative embodiment;

FIG. 4 illustrates a general thermal imaging module comprising two sub-modules according to an illustrative embodiment;

FIG. 5 illustrates a specific thermal imaging module and network interface according to an illustrative embodiment;

FIGS. 6 to 8 are flow charts for applications according to illustrative embodiments;

FIGS. 9 and 10 are flow charts for alternative methods according to illustrative embodiments;

FIG. 11 illustrates environmental monitors interfaced to network server functions according to an illustrative embodiment;

### DETAILED DESCRIPTION OF ILLUSTRATIVE EMBODIMENTS

One or more embodiments described herein may provide for installing a thermal monitoring system for both enclosed and open spaces conveniently with little or no infrastructure modification.

One or more embodiments described herein may provide for inexpensive, battery powered thermal imaging monitors with long battery life.

One or more embodiments described herein may provide convenient interfacing of the thermal imaging monitors to the internet for remote control and data acquisition.

One or more embodiments described herein may provide for a variety of environmental reporting including temperature alerts for specific regions of the space along with thermal images and temperature maps if desired.

One or more embodiments described herein may allow for environmental monitors from multiple users to access server function on a network such as the internet, and for users to access their monitors and monitor data through accounts.

The environmental monitor systems and methods may include modules, sub-modules and system controllers which in turn may include computer methods including programs or applications or digital logic methods and may be implemented using any of a variety of analog and/or digital discrete circuit components (transistors, resistors, capacitors, inductors, diodes, etc.), programmable logic, microprocessors, microcontrollers, application-specific integrated circuits, or other circuit elements. A memory configured to store computer programs and may be implemented along with discrete circuit components to carry out one or more of the processes described herein. In a particular embodiment, an environmental monitor may include one or more modules including imaging sensors which may be a Focal Plane Array (FPA), which may be part of a camera core or thermal imaging module or submodule. Some processing and memory components may be on the module or submodule, and others may reside on other separate computerized devices including other submodules, smart phones, tablets and computers or any combination thereof. In other embodiments some processing and memory elements may be implemented using programmable logic, such as an FPGA, which are part of the core, module or camera system. The modules and the computerized devices may communicate over a network, including wireless networks.

In some embodiments, image data may be provided by a thermal imaging system usually including a Focal Plane Array (FPA) imaging sensor. An example of such a system is an infrared (IR) camera core, including an IR FPA and associated optics and electronics.

An FPA typically includes a two dimensional array of pixels including X by Y photodetectors, which can provide a two-dimensional image of a scene. For imaging purposes, image frames, typically data from all or some of the detectors (frame or subframe), up to X*Y pixels per frame, are produced by the FPA, with each successive frame containing data from the array captured, and typically converted from analog to digital form, in successive time windows. Thus, a frame (or subframe) of data delivered by the FPA will consist of a number of digital words, representing each pixel in the image, ie data from each detector. These digital words are usually the length of the analog to digital (A/D) conversion process, for example if the pixel data is converted with a 14 bit A/D, the pixel words are 14 bits in length, and there would be 16384 (2¹⁴) counts per word. For an IR camera used as a thermal imaging system, these words may correspond to a map of intensity of radiation in a scene measured by each pixel in the array. The intensity per pixel for a micro-bolometer type of photodetector IR FPA, for example, usually corresponds to the temperature of the corresponding part of the scene, with lower values corresponding to colder regions and higher values to hotter regions. It may be desirable to display this data on a visual display as an image of relative temperature vs position, or otherwise process and use the temperature information.

Each pixel in an FPA may include the radiation detector itself, which for an IR imaging array may generate relatively small signals in response to the detected radiation. Pixels may include interface circuitry including resistor networks, transistors and capacitors on a Readout Integrated Circuit (ROIC) that may be directly interfaced to the array of detectors. For instance, a microbolometer detector array, which is a MEMS (Microelectrical Mechanical System) construct may be manufactured using a MEMS process building up the microbolometers onto an ROIC which is fabricated using electronic circuit fabrication techniques. When complete the ROIC with the micro-bolometers integrated onto it combine to form an FPA.

A thermal imaging environmental monitoring module may be formed from an FPA, with associated electronics and optics, processing logic, and a wireless interface. These elements may be alternatively be apportioned across two or more submodules, which when interfaced together form a complete environmental monitor module. A thermal imaging environmental monitoring system may be formed including one or more such modules along with one or more computerized devices executing suitable programs or applications and/or digital logic, and interfaced to the modules across one or more wired or wireless networks.

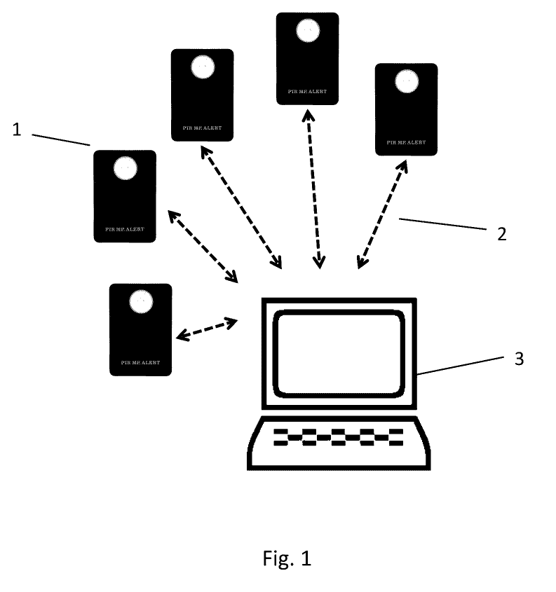

Referring to FIG. 1, a general block diagram of an illustrative embodiment of a thermal imaging environmental monitoring system is shown. A variety of modules 1, including a thermal imager may be placed in such a way as to observe a Field of View (FOV) of a space, such as the interior of a building or an exterior space, where it may be desirable to periodically monitor thermal characteristics of portions of that space over an extended time. An example of such a space may be a machinery or processing facility where fluids of various temperature are moved by motor driven pumps, leading to a multitude of regions within the space where region temperature over time is of interest. Module 1 communicates over network 2 with at least one system control computing device 3.

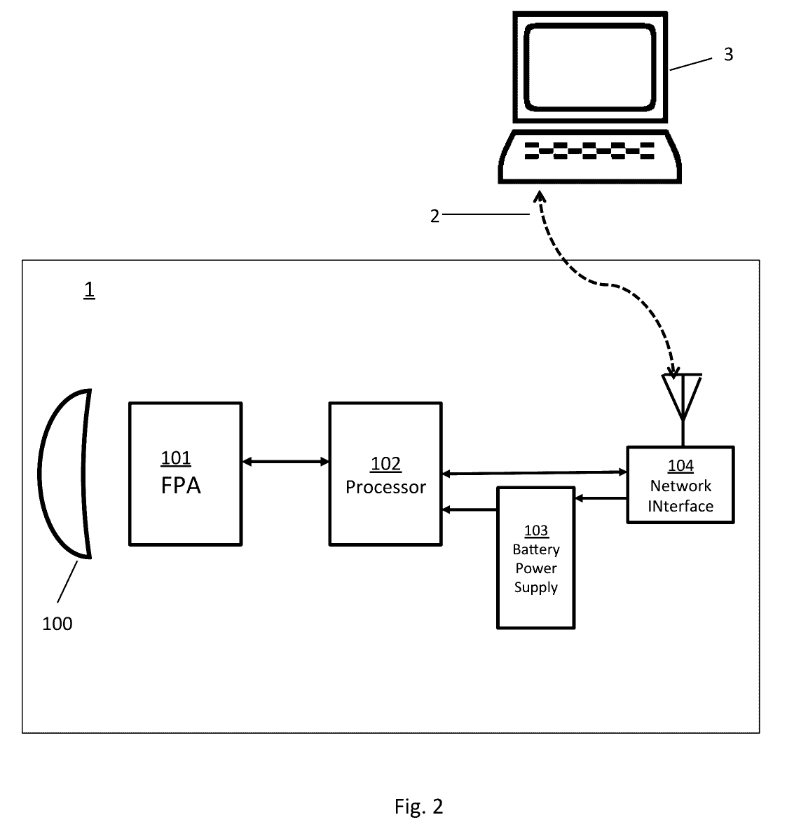

FIG. 2 is a simplified block diagram showing general elements for an illustrative embodiment of a thermal imaging module 1. Optics 100 gathers thermal radiation onto FPA 101. Processor 102 both acquires and processes scene data from FPA 101 and communicates with external elements over network interface 104. Processor 102 may be functionally distributed over multiple elements, such as microprocessors, FPGA's, etc. each handling a different portion of the image processing, sequencing, and communication tasks. In a particular embodiment, Module 1 may be battery powered, 103. A battery powered module 1 with a wireless network interface may be advantageous, as it allows for modules to be placed in a space with minimal or no infrastructure changes to the environment, by simply attaching the modules through a variety of simple means, where desired, with no need for any power, wiring, or other infrastructure support. Thus such a system may be conveniently installed in an existing environment with little to no site preparation or modification.

In one embodiment, utilizing a battery powered module 1, the processor 102 and network interface 104 may be chosen to support a quiescent, very low power mode of operation, sometimes referred to as sleep mode. For such a system, the processor may be configured to go into sleep mode, which for some embodiments includes powering down the FPA 101. For a suitably designed system, sleep mode may consume very little power, leading to the potential for long battery life. The module 1 may be periodically woken from sleep mode, either in response to a timer running on the processor initiating a periodic wake-up sequence, or alternatively in response to a signal received over the network initiating a wakeup sequence. Both modes of operation are supported in low power for available processors and/or network interface circuits. The wake-up operation may include powering up the FPA, waiting for a suitable stabilization time, if desirable, and acquiring one or more thermal image frames. Depending on what is observed in the image data, either a report may be issued across the network, and/or the module may either go back to sleep, or stay awake for continuous monitoring if the observed situation requires continuous monitoring.

In one embodiment, the processor may be configured to divide the image frame into one or more regions, corresponding to elements within the viewable scene of the module. For instance if a module is placed such that the scene it can observe includes, a pump, a power module, and a heated section of pipe, the frame of image data may be subdivided into regions corresponding to defined areas around those elements. The module processor may include a thermography process that converts measured pixel intensity to temperature, such as described in application Ser. No. 14/838,000 commonly owned by the same owner as the current application. Thus a thermographic analysis of the region may be performed. Such an analysis may provide a region temperature, or temperature of any part of the image. The thermographic analysis may include for example, the average, the median or the minimum/maximum of the pixels in each region, or any other suitable analysis, and may be determined for each defined region of the scene. When the module is in wake mode, one or more frames of data may be acquired and region temperatures may be compared to predetermined thresholds. If the actual measured temperature does not fall within the thresholds, the module may communicate this information over the network to a system controller.

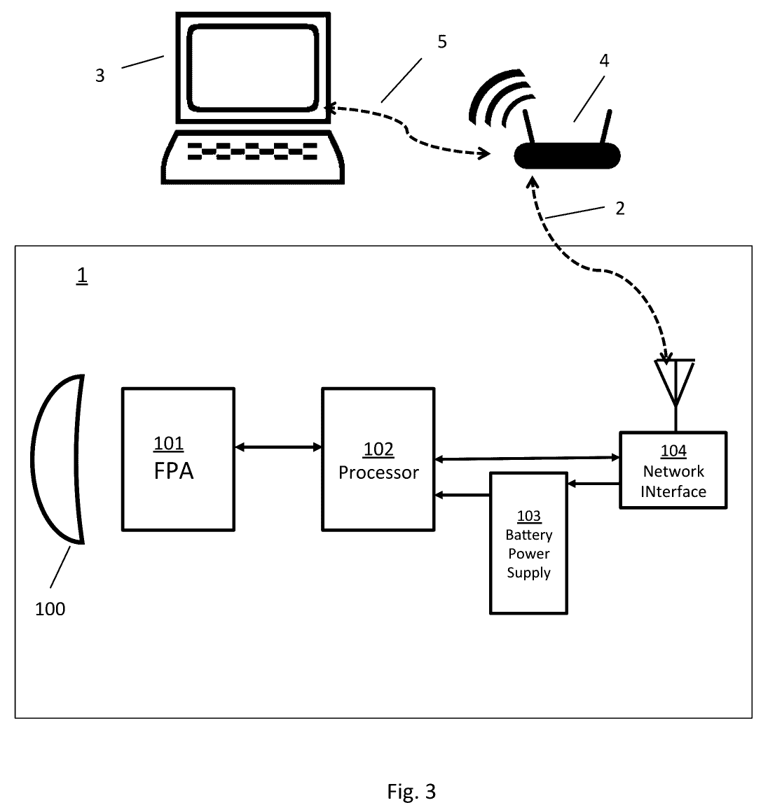

FIG. 2 illustrates a system where the modules 1 communicate with the system controller 3 over a wireless network. The wireless network in some embodiments may be a local low power network. Such networks include smart Bluetooth, Zigbee, certain implementations of WiFi and others. However, as shown in FIG. 3, it may be desirable to have the system controller either more remote or part of an existing industrial network with a centralized controller at a distance from any particular module, while still maintaining a low power local network to conserve module battery life. Thus it may be desirable to use a bridge 4, such as a local smart Bluetooth bridge for example, between the modules and a wider area, higher power network, such as standard Wi-Fi to the Internet for example. Since such a bridge may simply plug into wall power, the ability to install the environmental monitor system with little or no infrastructure preparation is maintained in this embodiment.

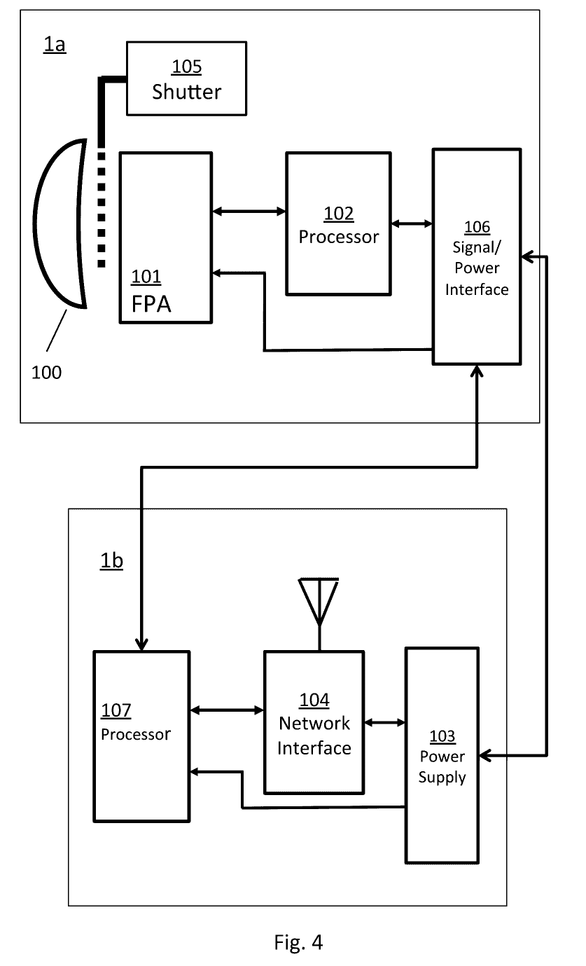

The sensor portion of the module, the optics, FPA, and some level of processor, may be in many cases be a multi-purpose thermal imager and one design may work well for many different installations and uses. However certain infrastructure elements such as available power, mounting requirements, type of network and so on may be installation specific. Thus it may be beneficial for manufacturing and system cost considerations to form the monitoring modules from two sub-modules as shown in FIG. 4. Sub-module 1a contains optics 100, FPA 101, optional shutter 105, processor 102 and signal/power interface 106. Processor 102 for this embodiment operates the FPA, but may not need to perform other tasks in some installations. Sub-module 1a may be a standardized, suitable for many different installations and uses. Sub-module 1b may be installation specific, containing its own processor 107, installation specific network interface 104 and power supply 103. Sub-module 1b may also be physically configured as required for mounting and in general fitting into a specific installation. Sub module 1b may for some embodiments provide power to sub module 1a and handle data in and data out from sub-module 1a. Sub-modules 1a and 1b when mated together electrically form a complete module. They may or may not be mated physically, although the fact that 1a is standard and 1b is installation specific may more often than not dictate both physical and electrical mating. It is also possible that sub-module 1b could interface to more than one sub-module 1a

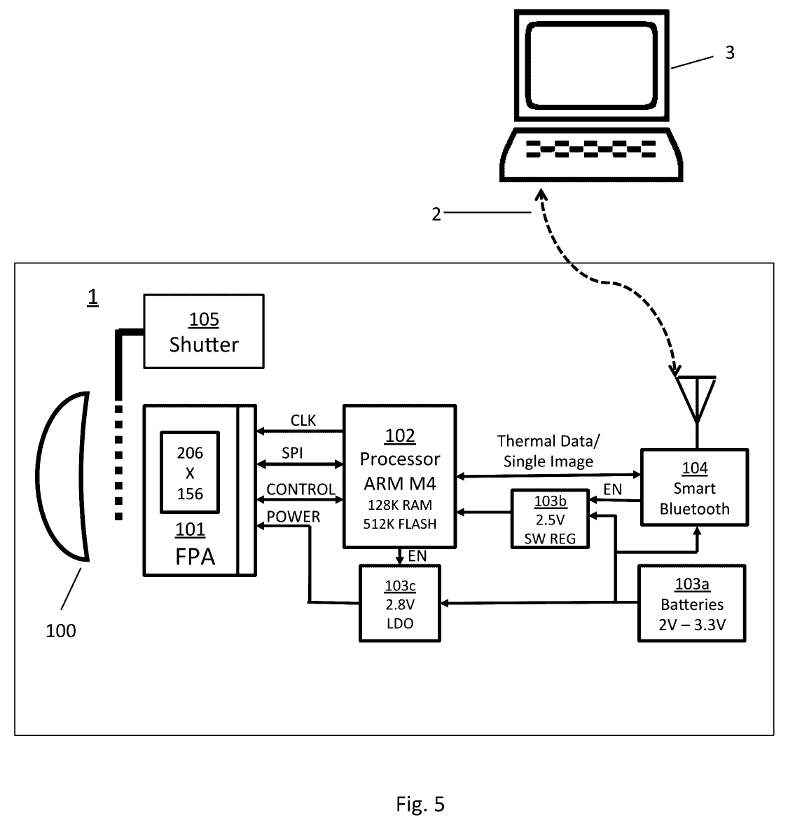

FIG. 5 is shows a more detailed example embodiment showing actual components that may be suitable for use in such a system.

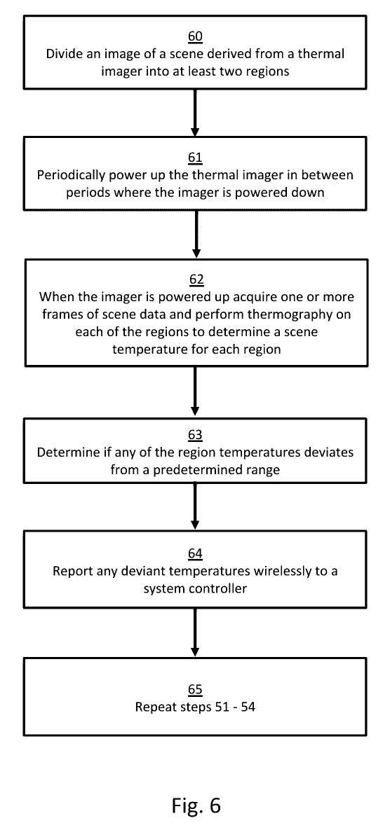

As shown in FIG. 6, a variety of actions may be taken by the module in response to an observed temperature out of range condition. Common steps (60 to 63), (70 to 73), and (80 to 83) include dividing the scene into regions, periodically waking the module from sleep mode and acquiring thermal images, and performing thermography on the scene data and determining if any region temperature is outside of predetermined ranges.

In a simple mode of operation, FIG. 6, any region temperature deviation may be reported across the network 64, and the module may go back to sleep until the next wake-up event 65.

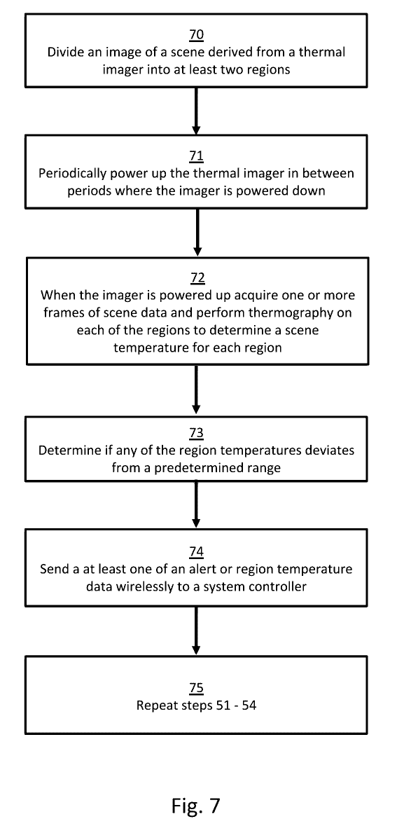

In FIG. 7, step 74 may include the option of sending an alert along with or in place of temperature data.

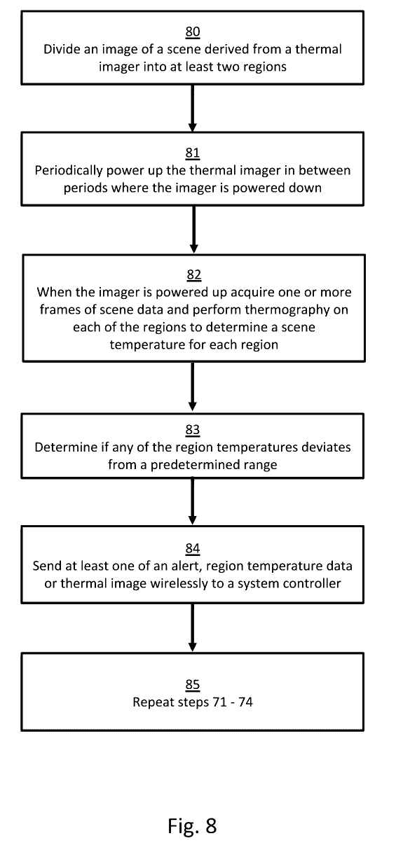

In FIG. 8, step 84 may include the option of sending a complete or region image as well as or in place of alerts and/or temperature data.

Other operating steps may be envisioned. For instance, depending on the severity or location of the deviant temperature, the module may be instructed or programmed to go into continuous imaging/reporting mode until instructed otherwise.

The system includes a responsive program executing on controller 3, which can handle alerts or deviant temperature reporting in a suitable manner.

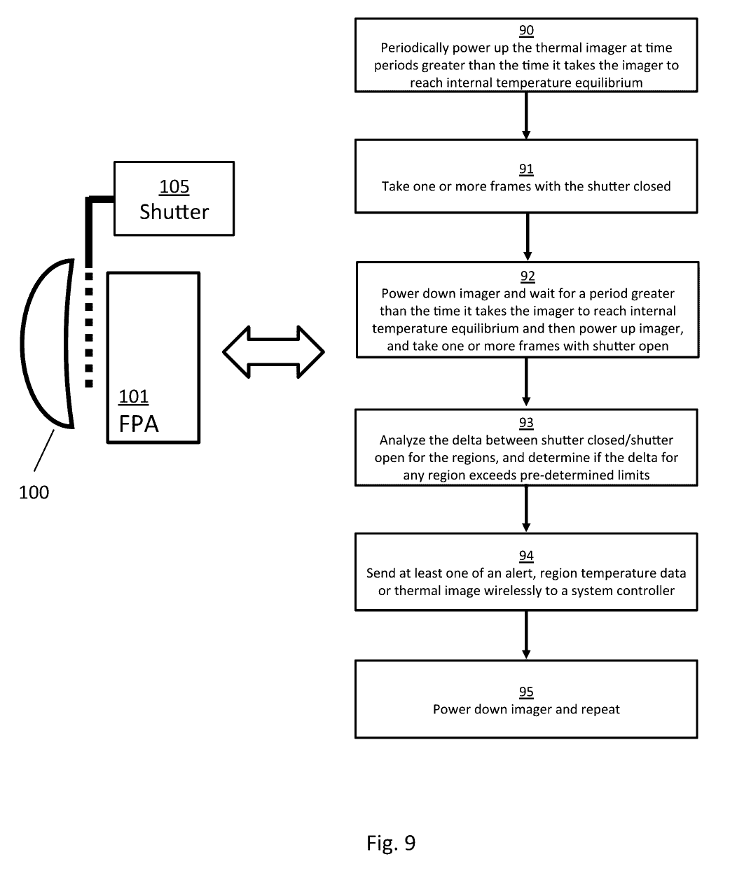

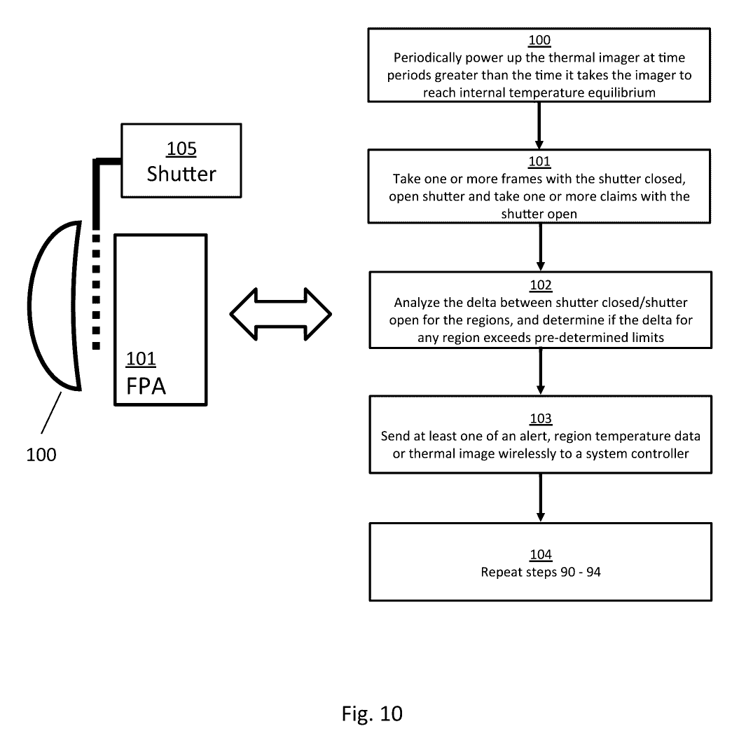

FIGS. 9 and 10 illustrate a mode of operation for systems with a shutter 105 that may allow for even lower power consumption for some types of thermal imagers. Performing accurate thermography usually entails that an FPA be powered up and imaging for a multitude of frames to allow for thermal stabilization and to perform all of the corrections and other operations necessary for accurate thermal data. Thus determining actual temperatures requires that a module operate for 10's of seconds or more each wake period. However, in powered down mode, after a sufficient time the module will come to near ambient temperature, where the FPA and shutter are in thermal equilibrium with each other and the surrounding environment. Thus if a frame of data is taken with the shutter closed immediately upon power up, the data will represent each pixel's equivalent of room temperature. If a single frame is taken shutter open, then the delta between the shutter closed and open frame for each pixel is the delta between the scene temperature and room temperature. These deltas may be used as thresholds without actually knowing the temperature accurately simply by comparing to baseline scenes where the scene temperature are within expected ranges. Thus a mode of operation may be used where the module only need acquire a few, or even single, frames at a time, leading to power on times of less than a second if no deviations are observed. The result may be very low power consumption and very long battery life.

One method embodiment of the shutter-based technique is shown in FIG. 9. In step 90 the imager (module) is powered up at intervals long enough for the FPA and shutter and other elements to reach thermal equilibrium. In step 91, one or at most a few frames of data are taken with the shutter closed. In step 92, the image is powered down for a period long enough to reach equilibrium, and one or at most a few frames of shutter open data are taken. In step 93 the data is analyzed to determine if any region has deltas between the shutter open and closed frames that exceeds predetermined thresholds. In step 94, any deviations are reported and acted on and in step 95 the steps are repeated. In FIG. 10, a similar process is shown, with the shutter open and shutter closed frames taken on the same power up cycle.

Although, a system controller is shown is the Figures, it is understood that such a controller may not be present in any given installation but just need be reachable over a network. In fact the modules could be configured to report to and receive instructions from a cloud based controller. This would allow for modules anywhere in the world to be accessed from anywhere in the world and the “controller” is at the server level. It would also allow for use of the modules to be handled as a subscription service where the modules report to the cloud, data from multiple installations is handled at the cloud level and deviations are reported over various networks, such as email alerts, text messages and the like.

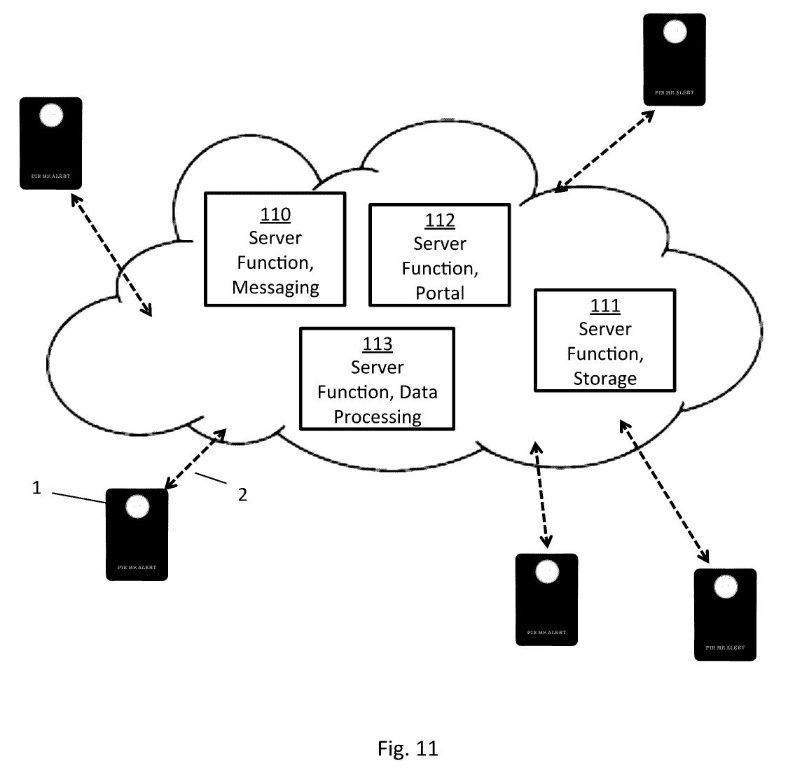

Such a system is shown in FIG. 11 where modules 1 interface over a network 2 to network servers, which implement the environmental monitor system's functions 110 to 113. Although, low power, battery powered, intermittent operation monitors have been disclosed, the network based system applies to any type of monitor module and any type of operation.

Any physical layer may be used to access the network, including wi-fi, Ethernet, local networks such as Bluetooth, Zigbee and the like, cellular communication, microwave communication, IR communication, satellite phone, and others. The connection can be direct to the network, or through a local bridge or relay, as long as each module has a gateway to the network. The network may be proprietary network, but for many embodiments it is envisioned that the network will be the internet. The system controller functions described above may be apportioned across one or more servers implementing server functions.

In some embodiments, monitors belonging to individual users installed at a variety of sites and/or locations may all interface to the server based control system. Each use may access their individual monitors and the data acquired from their monitors through an account based system.

Example server functions are shown in FIG. 11. Messaging 11 handles module communication and commands, identifying each module on the network and directing two-way messaging between the module, the module owner and the other server functions. Module data acquired may be stored on the network (cloud storage) allowing for the ability to store data representing long periods of time. Such longterm storage and access allows for the possibility of identifying trends and patterns, and in particular thermal patterns that indicate potential failure of an item the monitors are observing. In fact, the system can be configured to observe and correlate thermal patterns for similar devices from multiple users to build up learning of thermal signatures and patterns that correlate to failure conditions, which may benefit all users of the system.

Data processing 13 may also take place at the server level, again distributed over all monitors interface to the network.

A portal 112 is an important piece of the system. The portal is the user interface and allows for set-up and access to data for users. For instance the portal is where the user can identify the location of each module in his installation, set-up parameter such as image regions and thresholds for each region, implement trending routines, and define protocols for data storage, processing and reporting, such as what kind of data, such as region temperature, whole images or real time imaging happens in response to specified conditions. The portal is also where the user can specify how notifications of alarm or other conditions of interest will be communicated. Having the system controller functionality at the internet level offers a wide variety of communications possibilities. Emails, text messages and phone calls are all possible as well as communication to any networked entity such as user on-site automation (factory controllers or individual networked devices). It is possible that if an over-temperature condition is observed for a piece of networked equipment (process equipment, motor, pump or many other types) any or all of a text message could be sent to appropriate users, a factory controller could be notified and the individual device's warning system (Christmas tree lighting, audio alarm etc) could be activated. All of the set-up can be customized and personalized on a per module basis.

In addition to thermal imaging, environmental monitors may benefit from carrying other sensors that provide additional and/or complimentary data to the thermal. Sensors such as visual imagers, ambient temperature, ambient power, humidity and others may all add to the effectiveness of a networked monitor system.

Also, monitors may not necessarily be used solely in fixed installations. Thermal monitoring may apply to moving installations such as vehicles (cars, trucks aircraft etc) or large mobile equipment such as construction or mining vehicles, or be transported, ie mounted to vehicles or carried, to observation location areas. Thus a GPS module may also be advantageously included in a monitor module.

The embodiments described herein are exemplary. Modifications, rearrangements, substitute devices, processes, etc. may be made to these embodiments and still be encompassed within the teachings set forth herein. One or more of the steps, processes, or methods described herein may be carried out by one or more processing and/or digital devices, suitably programmed. One or more of the electronic, optical, and other system components may be replaced with alternate elements.

1. A system for thermal monitoring of a Field of View (FOV), comprising;
a. at least one thermal imaging module, comprising;
1. an Infrared Focal Plane Array (IR FPA) and optics for producing a thermal image of a scene including a portion of the FOV,
2. at least one processor,
3. a battery based power supply controlled by the processor, and;
4. a network interface to the processor,
b. an application executing on the processor, configured to;
1. put the module into a low power mode, wherein only minimal timing and network interface functions are operable,
2. for at least one of predetermined intervals or in response to a network wake-up command, power up module and acquire thermal image data of the scene,
3. segment the image of the scene into two or more regions,
4. perform thermographic analysis to determine the temperature of each region,
5. return to low power mode and repeat, and;
c. at least one system controller in communication with the modules over the network.

2. The system of claim 1 wherein the application is further configured to, depending on the region temperatures determined, at least one of;
a. sending region temperature over the network;
b. send at least one of an alert or region temperature data over the network interface if the temperature of any region deviates from a predetermined range, or;
c. send a scene thermal image over the network interface.

3. The system of claim 1 wherein the network interface is a low power local network.

4. The system of claim 1 wherein the network interface communicates to at least one of a local bridge which in turn communicates at least one of over the internet, or directly to the internet.

5. The system of claim 3 wherein the network interface includes at least one of Bluetooth, Zigbee, wi-fi, cellular, satellite telephone, or IR.

6. The system of claim 1 wherein the thermographic analysis includes one or more of average, median, minimum or maximum temperature of the regions.

7. The system of claim 4 wherein the network is smart Bluetooth and the bridge is a Bluetooth bridge.

8. The system of claim 1, wherein the system controller functions reside in one or more servers on the Internet.

9. The system of claim 8 wherein the server system controller functions include messaging, data storage, data processing, and a web portal.

10. The system of claim 9 wherein environmental monitors from multiple users interface with the server functions and each user accesses their environmental monitors and associated data through an account.

11. The system of claim 9 wherein system operation protocol including one or more of environmental monitor set-up, data processing protocol, alarm conditions, notification configuration, and data retrieval/display is accessed through the web portal server function.

12. The system of claim 11 wherein notifications, including any alarm conditions, are sent from the servers to users through one or more of email, text messages, telephone calls, or direct communication to user facility automation.

13. The system of claim 8 wherein data patterns and trends are monitored over time by long term storage and analysis of monitor data.

14. The system of claim 1 wherein the environmental monitor includes sensors including one or more of visual imager, ambient temperature sensor, ambient humidity sensor, local power monitor, and GPS module.

15. The system of claim 1 including a rechargeable battery, wherein the battery may be charged by one of a solar recharger or an local power charger.

16. The system of claim 1 wherein the thermal imaging module comprises;
a first sub-module comprising Infrared Focal Plane Array (IR FPA) and optics for producing a thermal image of a scene including a portion of the FOV, at least one processor, and a signal/power interface to a second sub-module; and,
the second sub-module comprising at least one processor, a power supply controlled by the processor, a signal/power interface to the first sub-module and a network interface to the processor;
wherein the first sub-module is a generic thermal imaging component, the second sub-module is an installation specific sub-module and the two interface together to form the environmental monitoring thermal monitor.

17. A method for thermal monitoring of a FOV utilizing one or more networked interfaced, battery powered thermal imaging modules capable of operating in low power quiescent and active modes, comprising;
a. waking up the imaging module on at least one of a periodic time interval or in response to a wake-up command received over the network;
b. acquiring scene image data of at least a portion of the FOV,
c. segmenting the image of the scene into at least two regions
d. performing a thermographic analysis of the image data to determine a temperature of each region,
e. returning to low power mode and repeating steps a-d.

18. The method of claim 17 wherein the thermographic analysis includes one or more of average, median, minimum or maximum temperature of the regions.

19. The method of claim 17 further comprising, depending on the region temperatures determined, at least one of;
a. Sending region temperature data over the network interface;
b. sending at least one of an alert or region temperature data over the network interface if the temperature of any region deviates from a predetermined range, or;
c. sending a scene thermal image over the network interface.

20. A method for thermal monitoring of a FOV utilizing one or more networked interfaced, thermal imaging modules capable of operating in low power quiescent and active modes, including a shutter and a thermal sensor, comprising;
a. waking up the imaging module on at least one of a periodic time interval or in response to a wake-up command received over the network, wherein that interval is of sufficient time for the thermal sensor and shutter to reach thermal equilibrium;
b. acquiring at least one of at least one frame of image data with the shutter closed, at least one frame with the shutter open, or both shutter open and shutter closed frames of at least a portion of the FOV,
c. segmenting the image of the scene into at least two regions
d. determining if intensity of a region from a shutter open frame exceeds a predetermined difference from the intensity of the region with the shutter closed an if so, at least one of; sending at least one of an alert or region temperature data over the network interface, or; sending a scene thermal image over the network interface.
e. returning to low power mode and repeating steps a-d.
